(19) United States
(12) Patent Application Publication
(10) Pub. No.: US 2022/0374683 A1
(43) Pub. Date: Nov. 24, 2022

(54) SELECTING POINTS IN CONTINUOUS SPACES USING NEURAL NETWORKS

(71) Applicant: DeepMind Technologies Limited, London (GB)

(72) Inventors: Thomas Edward Eccles, London (GB); Ian Michael Gemp, London (GB); János Kramár, London (GB); Marta Garnelo Abellanas, London (GB); Dan Rosenbaum, London (GB); Yoram Bachrach, London (GB); Thore Kurt Hartwig Graepel, Cambridge (GB)

(21) Appl. No.: 17/668,050

(22) Filed: Feb. 9, 2022

Related U.S. Application Data
(60) Provisional application No. 63/187,730, filed on May 12, 2021.

(51) Int. Cl. G06N 3/04; G06K 9/62

(52) U.S. Cl. CPC G06N 3/0454; G06K 9/623

(57) ABSTRACT

Methods, systems, and apparatus, including computer programs encoded on computer storage media, for selecting an optimal feature point in a continuous domain for a group of agents. A computer-implemented system obtains, for each of a plurality of agents, respective training data that comprises a respective utility score for each of a plurality of discrete points in the continuous domain. The system trains, for each of the plurality of agents and on the respective training data for the agents, a respective neural network that is configured to receive an input comprising a point in the continuous domain and to generate as output a predicted utility score for the agent at the point. And the system identifies the optimal point by optimizing an approximation of the shared outcome function that is defined by, for any given point in the continuous domain, a combination of the predicted utility scores generated by the respective neural networks for each of the plurality of agents by processing an input comprising the given point.

### CROSS-REFERENCE TO RELATED APPLICATION

This application claims priority to U.S. Provisional Patent Application No. 63/187,730, on May 12, 2021, the disclosure of which is hereby incorporated by reference in its entirety.

### BACKGROUND

This specification relates to selecting points in continuous spaces using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

Selecting optimal points in a parameter space for a plurality of agents has many applications related to group decision making. Techniques have been developed for selecting points in discrete domains containing a finite set of alternatives. This specification provides a system and associated method that selects an optimal point in a continuous parameter space using neural networks

In one aspect of the specification, a method is provided for making an optimal decision for a plurality of agents. The method can be implemented by a computer system. The system receives a request to identify an optimal point in a continuous domain for a plurality of agents. The continuous domain can be in a one-dimensional, a two-dimensional, or an N-dimensional (N≥3) parameter space. The optimal point defines a feature point in the continuous domain that maximizes a shared outcome function for the plurality of agents. After receiving the request, the system obtains training data from each agent. The training data from each agent includes a plurality of utility scores for a plurality of discrete points in the continuous domain. In some implementations, the system can query an agent on randomly selected discreet points in the continuous domain, and the agent can assign a utility score for each of the discreet points in the query. After receiving the training data from the agents, the system trains a respective neural network for each agent based on the training data. For each agent, the respective neural network predicts a utility-value function for the agent. Concretely, the respective neural network is configured to receive an input including a point in the continuous domain, and to generate as output a predicted utility score for the agent at the point. Through training, the system learns a set of network parameters for each neural network based on the plurality of utility scores received from the respective agent. The system further identifies the optimal point by optimizing an approximation of the shared outcome function. The shared outcome function is a combination of the predicted utility-value functions for the plurality of agents, and is defined by, for any given point in the continuous domain, a combination of the predicted utility scores generated by the respective neural networks for each of the plurality of agents by processing an input comprising the given point. The shared outcome function can include a sum or a weighted sum of the predicted utility-value functions of the respective plurality of agents.

The system can identify the optimal point for the shared outcome function using a gradient ascent method. The process includes selecting an initial point in the continuous domain and iteratively taking steps in the direction of an approximate gradient of the shared outcome function to identify a local maximum of the function. In some implementations, the system can identify a plurality of local maxima of the shared outcome function by repeating the process with multiple initial points and identify a global maximum from the plurality of local maxima as the optimal point.

In some implementations, the system further calculates an agent-specific cost for each agent. The system identifies, according to the sets of neural network parameters, an agent-specific reject location for the agent in the continuous domain that maximizes an agent-rejection outcome function with respect to locations in the continuous domain. The agent-rejection outcome function includes a sum of utility-value functions of all other agents in the plurality of agents. To identify the agent-specific reject location, the system can locate one or more local maxima of the agent-rejection outcome function using a gradient ascent algorithm, and identify a global maximum from the local maxima as the agent-specific reject location. The system further calculates a first sum of utility values of all other agents in the plurality of agents at the agent-specific rejection location, calculates a second sum of utility values at the optimal location of all other agents in the plurality of agents, and calculates the agent-specific cost for the agent according to the first sum of utility values and the second sum of utility values.

In general, the described system and methods provide a solution for selecting an optimal point in a continuous decision domain that optimizes a shared outcome for a plurality of agents. The provided methods can also be desirable in scenarios where a finite but a very large number of candidate locations are required. In those scenarios, techniques based on discrete domains including a finite set of alternatives become inefficient and cumbersome, since the querying process and computational load grow rapidly with increased number of candidate locations. Thus, the described system and methods provide an efficient solution for a diverse range of applications that require identifying an optimal point in a parameter space.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a decision optimization system.

FIG. 2 shows an example of a decision optimization and cost estimation system.

FIG. 3 is a flow diagram of an example process for making a group decision over a continuous space.

Like reference numbers and designations in the various drawings indicate like elements.

### DETAILED DESCRIPTION

This specification generally describes a system and associated methods for making an optimized group decision for selecting a point in a continuous domain for multiple agents. The continuous domain can be in a one-dimensional, two-dimensional, or N-dimensional (N≥3) space representing the feature space in which the optimal decision is located. Each agent has a preference over the possible locations of the selection, and assigns different values for different locations in the domain. The goal of the system is to select a point in the continuous space to maximize a shared outcome among all agents, and calculate an agent-specific cost for each agent according to the agents' reported value assignments and the selected point.

Additionally, the described techniques can be used in scenarios where a finite but a very large number of candidate decision locations are required, since in standard implementations for identifying a decision point in a discrete decision domain, the querying process and computational load grow rapidly with increased number of candidate locations. Thus, the described system provides an efficient solution for a diverse range of applications that require identifying an optimal point in a parameter space.

In some implementations, the plurality of agents can be a plurality of computing node devices in a distributed computing system. In this scenario, the continuous domain can be the network-traffic feature space, representing parameters such as bandwidth allocation for each node device, average data packet sizes, buffer sizes, and session time. The plurality of computing node devices can be heterogeneous, i.e., they do not have the same preference for the network traffic configuration properties to maximize their respective computing efficiencies. The described system and methods can be used to query each computing node device individually, and determine an optimal point in the network-traffic properties space to maximize the shared computing efficiency for all node devices in real time. In exchange to configuring the network traffic parameters at the optimal point in the feature domain, each node device can be assigned an amount of computational workload as part of a collaborative computational task.

In some other implementations, the plurality of agents can be a plurality of movable devices, such as robots or electrical vehicles, that move to a mobile power charging station for charging. The continuous domain is a two-dimensional physical space where the charging station is located. Each movable device (agent) has a preference for the location of the charging station depending on its current location and the task it is performing. In exchange to a selected location for the charging station, each agent can be assigned an amount of task for each charging. The described system and methods can determine an optimal location for the power charging station to maximize a shared efficiency for the plurality of movable devices.

In some other implementations, the plurality of agents can be multiple stakeholders that have different preferences for a location of a shared facility, such as a railway station, an airport, a storage facility, a complex for living, commercial, or office spaces, a community center, and so on. The continuous domain is a two-dimensional physical space where the shared facility is located.

In some other implementations, the plurality of agents can be multiple stakeholders that have different preferences for a time schedule for an event, such as a meeting, a performance, a broadcasted program, and so on. The continuous domain is the time domain in which the time schedule for the event is selected.

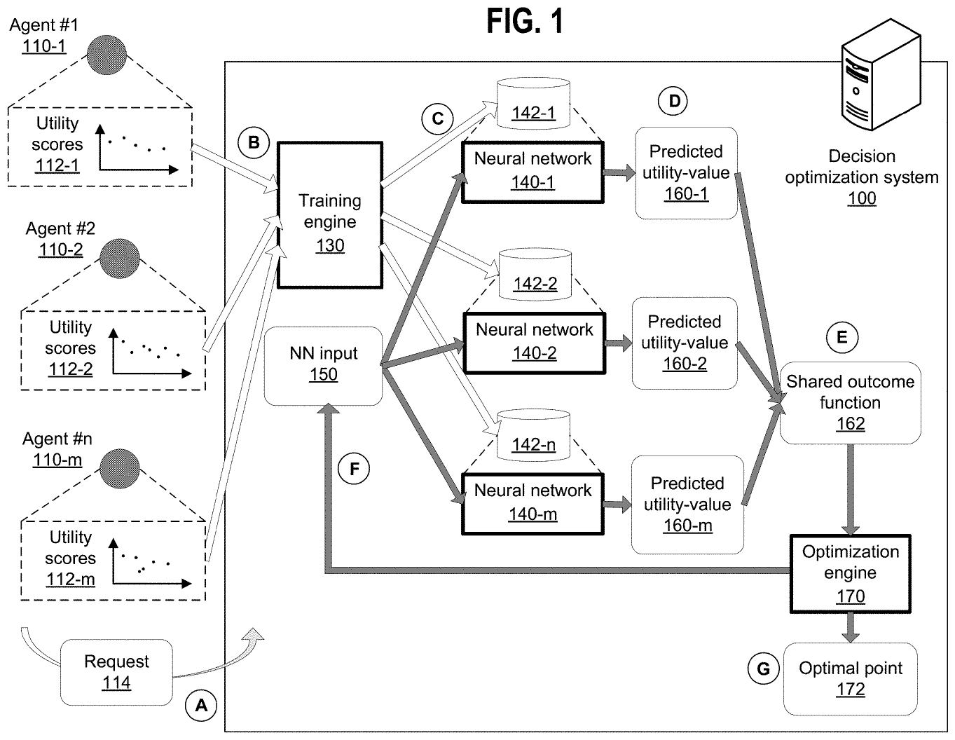

FIG. 1 shows an example of a decision optimization system 100 for selecting an optimal point in a continuous domain.

The system 100 can be implemented as one or more computer programs on one or more computers in one or more physical locations, and includes a training engine 130, a plurality of neural networks 140-1, 140-2, and 140-m, and an optimization engine 170.

Each of the plurality of neural networks corresponds to one of multiple agents and is used to predict a utility function of the respective agent. In the example shown in FIG. 1, neural network 140-1 corresponds to agent 110-1, neural network 140-2 corresponds to agent 110-2, and neural network 140-m corresponds to agent 110-m.

As shown in stage (A) of FIG. 1, the system 100 receives a request 114 to identify an optimal point in a continuous domain that maximizes a shared outcome function for the multiple agents 110-1, 110-2, and 110-n. The optimal point represents a feature point p in a continuous parameter domain D that the multiple agents need to jointly agree on. The continuous domain D can be in a one-dimensional space (i.e. [symbol] ⊂ [symbol] ), in a two-dimensional space (i.e. [symbol] ⊂ [symbol] ²), or in an N-dimensional space (i.e. [symbol] ⊂ [symbol] ^{N}≥3), depending on the dimensionality of the parameter feature.

In some application scenarios, each agent i has an agent-specific preference for the chosen location. The agent-specific preference can be expressed as a utility-value function vᵢ: [symbol] → [symbol] mapping any p∈ [symbol] to a utility score that represents a valuation of the feature point p to the i^{th} agent. These utility-value functions can be private information of the agents, with the i^{th} agent having only its own utility-value function vᵢ, but not those of the other agents.

For example, when allocating and configuring network resources for a distributed computing system, the i^{th} computing node device (agent) is associated with the utility-value function vᵢ that maps any network traffic configuration parameter feature point p to a value score vᵢ(p). The value score vᵢ(p) can signify a level of preference of the i^{th} node device for the parameter feature point p, such as a combination of allocated bandwidth, average data packet size, buffer size, and session time. The i^{th} node device can assign a different value score to a different network configuration parameter feature p. These utility-value functions can be private information for each of the computing node devices, with the i^{th} node device only having information with regard to its own vᵢ, but not those of the other node devices.

In the scenarios as the above, the system 100 can act as a central optimizer to select an optimal feature point p* in the parameter domain D that maximizes the total utility scores from all agents, that is, p*=argmax_{p∈D} Σᵢ vᵢ(p). The central optimizer can request all agents to report their utility-value functions vᵢ, but the agents may have an incentive to misreport their utility scores, so as to manipulate the optimizer to choose a feature point they prefer. For example, in allocating and configuring network resources for a distributed computing system, a node device may be simultaneously performing its own tasks in addition to performing the collaborative computational task. A local optimizer on the node device may be incentivized to report a utility-value function that does not truly reflect its valuations of the parameter domain to maximize the computational efficiency for performing a collaborative computational task.

To address the above problem, the Vickrey-Clarke-Groves (VCG) mechanism have been used to prescribe a framework for charging agents costs based on their reported utility scores, that dis-incentivizes agents from misreporting their valuations, thus enabling the central optimizer to choose the feature point that maximizes the true shared outcome for all agents. However, existing applications of the VCG mechanism typically deal with a discrete and finite set A of alternatives. Each agent can simply report their utility scores in the form of a table, listing vᵢ(a) for each element a∈A. The central optimizer can perform an algebraic calculation to choose the optimal alternative a* from the finite set A, and calculate the respective cost tᵢ(a*) for each agent i, according to the reported utility score tables.

However, the standard implementations of the VCG mechanism become intractable for making a selection from continuous domains. Further, even for the scenarios where A is finite but large, it is not only cumbersome for the agents to report their utility scores for all alternatives, but also inefficient for the central optimizer to make the selection of optimal alternative a* for the standard implementations of the VCG mechanism. As an example, the decision domain is a 2D spatial domain with a size of 1000 m×1000 m, in which a location is to be selected. Even if the 2D spatial domain can be discretized with a one-meter resolution, the decision domain still includes a large number (10⁶) of alternative locations. The standard implementations of the VCG mechanism are inefficient and cumbersome in this case.

The system 100 provides a framework to enable effectively selecting the optimal alternative in the continuous domain D or in a domain where D is finite but very large. In those scenarios, it is impossible or difficult for the central optimizer to receive a complete list of preferences from any of the agents, either because the space is continuous or because the state is very large and receiving the complete list is intractable. Instead, in system 100, the agents can have valuations over locations in a subset of an N-dimensional space ( [symbol] ⊂ [symbol] ^{N}). As shown in processes (B) and (C) of FIG. 1, the system 100 can query each agent i for their utility scores in a set of sampled locations, and use the utility scores received from each agent to train a respective neural network.

Concretely, in stage (B), the training engine 130 of the system 100 receives, from each of the plurality of agents 110-1, 110-2, and 110-m, respective training data 112-1, 112-2, and 112-m. The training data from each agent includes utility scores for a plurality of discrete points in the continuous domain [symbol] ⊂ [symbol] ^{N}. In some implementations, the system 100 can randomly select the discrete locations for each agent, send a query including the selected locations to the respective agent, and receive a reported valuation for each selected location from the respective agent.

In stage (C), the training engine 130 learns the sets of network parameters 142-1, 142-2, and 142-m of the neural networks 140-1, 140-2, and 140-m based on the training data from the respective agents 110-1, 110-2, and 110-m. The neural networks 140-1, 140-2, and 140-m are configured to predict the utility-value functions v (p) for the respective agents 110-1, 110-2, and 110-m based on their reported utility score sets 112-1, 112-2, and 112-m. That is, each neural network 140-1, 140-2, or 140-m is configured to receive an input including a point p in the continuous domain D and output a predicted utility score for the agent at the point.

Each of the neural networks 140-1, 140-2, and 140-m can be implemented with any suitable network architecture, such as a feed-forward neural network including one or more fully-connected layers, convolution layers, rectified linear unit layers, batch normalization layers, or pooling layers. The sets of network parameters 142-1, 142-2, and 142-m can include weight and bias coefficients for the network layers of the respective neural networks 140-1, 140-2, and 140-m. In some implementations, the plurality of neural networks 140-1, 140-2, and 140-m can all have the same network architecture. In some other implementations, the neural networks 140-1, 140-2, and 140-m can have a different network architectures for the different agents according to the properties of the agents.

The training process performed by the training engine 130 can be based on a cost function measuring the difference between the specified utility scores in the training data and the predicted utility scores. For example, the cost function can take the form of an L₂ loss. The training engine 130 can update the network parameters for each neural network through any appropriate backpropagation-based machine learning technique, e.g., using the Adam or AdaGrad optimizers.

After training the neural networks based on the valuation scores received from the agents, the system 100 can generate an approximation of a shared outcome function 162. The shared outcome function 162 is defined by, for any given point p in the continuous domain D, a combination of the predicted utility scores 160-1, 160-2, and 160-m generated by the respective neural networks 140-1, 140-2, and 140-m by using the given point p as input to the respective neural network. An example of this process is shown in stages (D) and (E) in FIG. 1.

In stage (D) of FIG. 1, for a given point p in the continuous domain D, the system 100 can use each of the neural networks 140-1, 140-2, and 140-m with the respective learned network parameters 142-1, 142-2, and 142-m to process a neural-network input 150 including the given point p, and generate respective neural network outputs 160-1, 160-2, and 160-m for that given point p. The respective neural network outputs 160-1, 160-2, and 160-m include predicted utility value scores of the given point p for the respective agents 110-1, 110-2, and 110-m. By varying the given point p across the continuous domain D, the system 100 can sample the predicted utility-value functions for the respective agents using the neural networks 140-1, 140-2, and 140-m. The i^{th} predicted utility-value function can take the form of v_{θ}_{ᵢ}_{′}(p), where the subscript θᵢ′ represents the reported valuation scores from the i^{th} agent and signifies that the predicted utility-value function is parameterized by the reported valuation scores from the respective agents.

In stage (E) of FIG. 1, the system 100 combines the predicted utility functions 160-1, 160-2, and 160-m to approximate the shared outcome function 162. In some implementations, the shared outcome function can be approximated as a sum of the predicted utility-value functions of the respective plurality of agents, i.e. s(p)=Σᵢ₌₁^{m}v_{θ}_{ᵢ}_{′}(p). In some other implementations, the shared outcome function can be approximated by a weighted sum of the predicted utility-value functions of the respective plurality of agents, where a weighting coefficient is assigned to each agent.

In stages (F) and (G) of FIG. 1, the system 100 performs an optimization of the shared outcome function 162 to identify the optimal point 172 in the continuous domain D. The optimal point, denoted by p*, is set to maximize the shared outcome function s(p), i.e. p*=argmax_{d∈D}s(d). Since each utility-value function v_{θ}_{ᵢ}_{′}(p) is captured by a respective neural network, the utility-value functions are differentiable models. The shared outcome function, being a combination of the utility-value functions, e.g., s(p)=Σᵢ₌₁^{m} v_{θ}_{ᵢ}_{′}(p), is also a differential model accordingly. The system 100 thus can perform an optimization of the shared outcome function 162 using any optimization method for finding a local maximum of a differentiable function. As an example, the optimization engine 170 of the system 100 can apply the gradient ascent method to identify the optimal point 172 for the shared outcome function 162.

Using the gradient ascent method as an example, the optimization engine 170 iteratively takes steps in the direction of an approximate gradient of the shared outcome function 162. As shown in staged (F) of FIG. 1, in each iteration, the optimization engine 170 can start with an initial point p₀ in in the continuous domain, and in each iteration, identify an updated location of a current point p′ in the continuous domain D according to the approximate gradient of the shared outcome function 162. The system 100 can calculate the predicted value-scores 160-1, 160-2, and 160-m and the shared outcome function 162 at the updated location of the current point p′ by performing stages (D) and (E) using the updated location of the current point as the neural-network input 150. The optimization can repeat the iterations until a convergence to a local maximum is reached, e.g., when an absolute value of the approximate gradient reaches below a threshold value.

The optimization process of stages (F) and (G) requires computing a global optimum. However, the Gradient Ascent method may converge on a local rather than global optimum. The optimization engine 170 can address this issue by starting the gradient ascent from multiple initial locations in the continuous domain D, and selecting the optimal location across these runs, i.e., selecting a global maximum among the local maxima obtained in the multiple runs. The optimization engine 170 can randomly select the initial locations in stage (F).

As an example of the optimization process, the optimization engine 170 can locate one or more local maxima of the shared outcome function 162. The optimization engine 170 can randomly select multiple initial points in the continuous domain D in stage (F). For each of initial point, the optimization engine 170 performs gradient ascent on the approximation of the shared outcome function 162 starting from the initial point, and locates the local maximum of the shared outcome function 162. Next, in stage (G), the optimization engine 170 identifies a global maximum from the one or more local maxima located using the multiple initial points. Alternatively or additionally, the system 100 can place a restriction on the form that the predicted utility-value function vᵢ can take, and use a representation form that allows for an optimization algorithm to better guarantee returning a global optimum.

In some implementations, the system 100 can implement active learning for a dynamic system by performing processes (B)-(G) on an ongoing basis. For example, the system 100 can continuously submit queries on randomly selected points p to the agents, and receive utility scores from the agents in real time. The training engine 130 can continually update the sets of network parameters 142-1, 142-2, and 142-m based on the utility scores received in real time. The optimization engine 170 can repeatedly perform the optimization process to update the optimal point 172 according to the updated sets of network parameters.

In addition to identifying the optimal point in the continuous domain, the system 100 can further calculate an agent-specific cost for each agent using the respective neural networks. The agent-specific costs can dis-incentivize the agents from making untruthful reports on the utility scores. For example, in allocating and configuring network resources for a distributed computing system, a node device may be simultaneously performing its own tasks in addition to performing the collaborative computational task. A local optimizer on the node device may be incentivized to report a utility-value function that does not truly reflect its valuations of the parameter domain with regard to the node's computational efficiency for performing the collaborative task. In order to dis-incentivize such behavior, the central optimizer can assign computation workloads as costs to the respective node that dis-incentivize the node devices from misreporting their valuations, thus enabling the central optimizer to choose the optimal network parameter feature that maximizes the true shared outcome for all node devices.

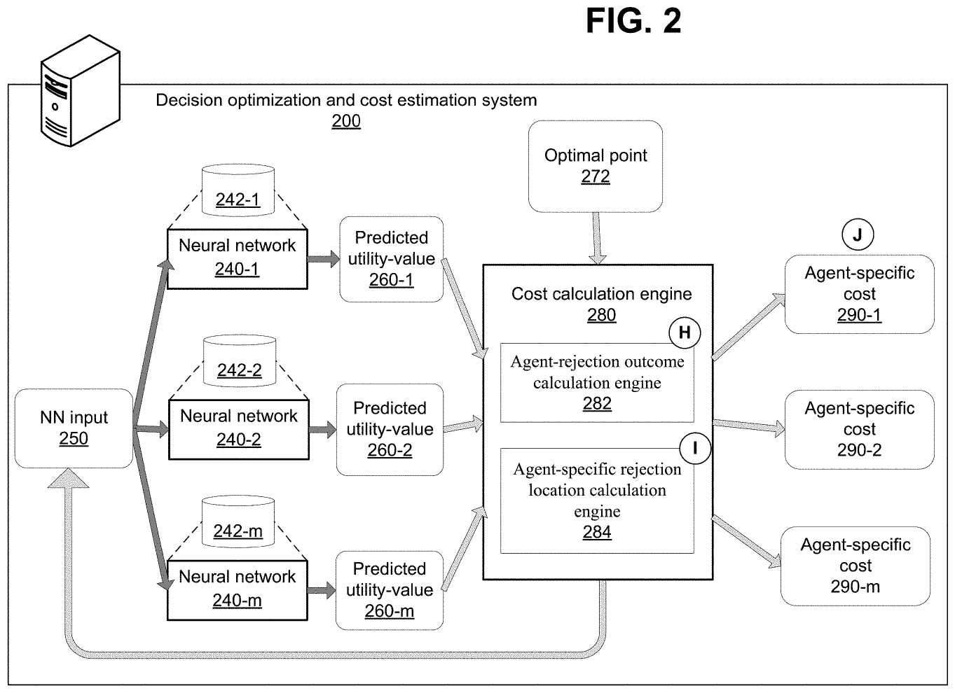

FIG. 2 shows an example of a decision optimization and cost estimation system 200. The system 200 can be implemented as one or more computer programs on one or more computers in one or more physical locations.

Similar to the system 100 in FIG. 1, the system 200 includes the plurality of neural networks 240-1, 240-2, and 240-m for the respective agents. The system 200 also include the training engine and optimization engine (now shown) for learning the sets of network parameters 242-1, 242-2, and 242-m and identifying the optimal point 272. The system 200 further includes a cost calculation engine 280 that processes the neural-network outputs 260-1, 260-2, and 260-m and the identified optimal point 272, and calculates agent-specific costs 290-1, 290-2, and 290-m in stages (H), (I), and (J).

In some implementations, the cost calculation engine 280 includes an agent-rejection outcome calculation engine 282 and a rejection location calculation engine 284. In stage (H) shown in FIG. 2, the agent-rejection outcome calculation engine 282 calculates, for the i^{th} agent, an agent-rejection outcome function, denoted by h₋ᵢ(p). The agent rejection outcome function h₋ᵢ(p) for agent i only takes into account the reports of agents other than the i^{th} agent. That is, the agent rejection outcome function h₋ᵢ(p) does not depend on the report θᵢ′ of the i^{th} agent. In some implementations, the agent-specific rejection location calculation engine 284 calculates the agent-rejection outcome function as a sum of the predicted utility-value functions of all other agents in the plurality of agents, that is, h₋ᵢ(p)=v_{θ}_{ⱼ}_{′}(p). The agent-rejection outcome function represents, for the i^{th} agent, a shared outcome function of all other agents.

In stage (I) shown in FIG. 2, the rejection location calculation engine 284 identifies, for the i^{th} agent, an agent-specific rejection location, donated by p₋ᵢ*. The agent-specific rejection location p₋ᵢ* relates to a maximum shared outcome that would have been chosen based solely on the reports of participants other than the i^{th} agent. That is, p*₋ᵢ=argmax_{p∈D}Σ_{j≠i} v_{θ}_{ⱼ}_{′}(p), or with simplified notation p*₋ᵢ=argmax_{p≠D}h₋ᵢ(p). For any of the agents, the agent rejection outcome function h₋ᵢ(p) is a differentiable function since it is a linear combination of the differential functions v_{θ}_{ⱼ}_{′}(p). Thus, the rejection location calculation engine 284 can identify the agent-specific rejection location p₋ᵢ* using any optimization method for finding a local maximum of a differentiable function, such as the gradient ascent method, similar to the process performed by the optimization engine 170 in FIG. 1. In some implementations, the rejection location calculation engine 284 can identify multiple local maxima for the agent-rejection outcome function by repeating the gradient ascent process using multiple initial points, and identify a global maximum from the multiple local maxima as the agent-specific rejection location p₋ᵢ*.

After identifying the agent-specific rejection location, the cost calculation engine 280 can calculate, for the i^{th} agent, the agent-specific cost based on the agent-specific rejection location, the predicted utility value functions of all other agents, and the optimal point 272. For example, the cost calculation engine 280 can calculate the agent-specific cost by subtracting the agent-rejection outcome at the optimal location from the agent-rejection outcome at the agent-specific rejection location. That is, the agent-specific cost for the i^{th} agent can be calculated as

tᵢ=Σ_{j≠i}v_{θ}_{ᵢ}_{′}(p*₋ᵢ)−Σ_{j≠i}v_{θ}_{ⱼ}_{′}(p*ᵢ). (1)

The first sum in Equation (1) is the agent-rejection outcome at the agent-specific rejection location h₋ᵢ(p*₋ᵢ). This term represents, for the i^{th} agent, a maximum shared utility-value for other agents based on the reports from all agents except for the i^{th} agent, as if the i^{th} agent were absent. The second sum in Equation (1) is the agent-rejection outcome at the optimal location h₋ᵢ(p*ᵢ). This term represents, for the i^{th} agent, the maximum shared utility-value for all other agents based on the reports from all agents. Calculating tᵢ using Equation (1) is in accord with the Clark pivot rule, and the resulted agent-specific cost tᵢ dis-incentivizes misrepresentation of the value scores.

In the application of allocating and configuring network resources for a distributed computing system, the agent-specific cost tᵢ for the i^{th} node device can be in the form of a computation workload assigned to the i^{th} node device as part of the collaborative computational task. Although the i^{th} node device may be simultaneously performing its own tasks, the agent-specific cost tᵢ can dis-incentivize the i^{th} node to misrepresent the reported value scores when queried by the central optimizer.

Next, the system 200 outputs one or more of the calculated agent-specific costs. In particular, the system can output one or more of the calculated agent-specific costs to one or more respective agents. In some implementations, the system can further incur one or more of the calculated agent-specific costs to, and receive the corresponding payments from, the respective agents. For example, in the application of allocating and configuring network resources for a distributed computing system, the agent-specific costs are the computation workloads calculated for the respective agents, and the system 200 can assign the calculated computation workloads to the corresponding node devices.

To summarize, the overall operation of the described systems 100 and 200 in the examples shown in FIG. 1 and FIG. 2 can include several components as illustrated by stages (A)-(J). In stage (A), the system receives a request to identify an optimal point in a continuous domain that maximizes a shared outcome function for a plurality of agents. In stage (B), the system obtains, for each agent, respective training data that includes utility scores for a plurality of discrete points in the continuous domain. In stage (C), the system learns, for each agent, a set of network parameters for a respective neural network. In stage (D), the system processes a network input using each of the neural networks to generate a predicted utility-value score for the respective agent. In stage (E), the system generates a shared outcome function based on the predicted utility-value scores. In stage (F), the system performs optimization on the shared outcome function using an optimization method. In stage (G), the system identify the optimal point based on the optimization result. In stage (H), the system calculates based on the predicted utility-value scores, for each agent, an agent-rejection outcome function that represents a shared outcome for all other agents considered by the system. In stage (I), the system performs an optimization process to identify, for each agent, an agent-specific rejection location that maximizes the agent-rejection outcome function. In stage (J), the system calculates, for each agent, an agent-specific cost based on the agent-rejection outcome at the agent-specific rejection location and the agent-rejection outcome at the optimal location.

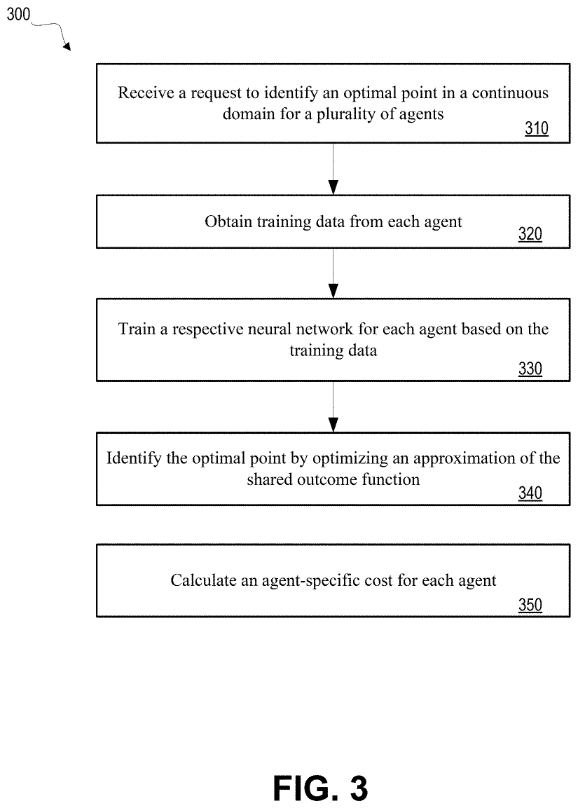

FIG. 3 is a flow chart illustrating a method 300 for selecting an optimal location in a continuous domain. The method can be implemented by a computer system, such as the system 100 in FIG. 1 and system 200 in FIG. 2. As shown in FIG. 3, the method 300 includes the following steps.

In Step 310, the system receives a request to identify an optimal point in a continuous domain for a plurality of agents. The continuous domain can be in a one-dimensional, a two-dimensional, or an N-dimensional (N≥3) parameter space. The optimal point defines a parameter feature in the continuous domain that maximizes a shared outcome function for the plurality of agents.

In Step 320, the system obtains training data from each agent. The training data from each agent includes a plurality of utility scores for a plurality of discrete points in the continuous domain. In some implementations, the system can query an agent on randomly selected discreet points in the continuous domain, and the agent can assign a utility score for each of the discreet points in the query.

In Step 330, the system trains a respective neural network for each agent based on the training data. For each agent, the respective neural network predicts a utility-value function for the agent. Concretely, the respective neural network is configured to receive an input including a point in the continuous domain, and to generate as output a predicted utility score for the agent at the point. Each neural network includes a set of network parameters. The system learns the set of network parameters for the neural network based on the plurality of utility scores received from the respective agent.

In Step 340, the system identifies the optimal point by optimizing an approximation of the shared outcome function. The shared outcome function is a combination of the predicted utility-value functions for the plurality of agents, and is defined by, for any given point in the continuous domain, a combination of the predicted utility scores generated by the respective neural networks for each of the plurality of agents by processing an input comprising the given point. The shared outcome function can include a sum or a weighted sum of the predicted utility-value functions of the respective plurality of agents.

The system can identify the optimal point for the shared outcome function using a gradient ascent method. The process includes selecting an initial point in the continuous domain and iteratively taking steps in the direction of an approximate gradient of the shared outcome function to identify a local maximum of the function. In some implementations, the system can identify a plurality of local maxima of the shared outcome function by repeating the process with multiple initial points and identifying a global maximum from the plurality of local maxima as the optimal point.

In Step 350, the system calculates an agent-specific cost for each agent. The calculation includes several components for each agent. The system identifies, according to the sets of neural network parameters, an agent-specific reject location for the agent in the continuous domain that maximizes an agent-rejection outcome function with respect to locations in the continuous domain. The agent-rejection outcome function includes a sum of utility-value functions of all other agents in the plurality of agents. To identify the agent-specific reject location, the system can locate one or more local maxima of the agent-rejection outcome function using a gradient ascent algorithm, and identifies a global maximum form the local maxima as the agent-specific reject location. The system further calculates a first sum of utility values of all other agents in the plurality of agents at the agent-specific rejection location, calculates a second sum of utility values at the optimal location of all other agents in the plurality of agents, and calculates the agent-specific cost for the agent according to the first sum of utility values and the second sum of utility values.

In Step 360, the system outputs one or more of the calculated agent-specific costs. In particular, the system can output one or more of the calculated agent-specific costs to one or more respective agents. In some implementations, the system can further incur one or more of the calculated agent-specific costs to, and receive the corresponding payments from the respective agents. For example, in the application of allocating and configuring network resources for a distributed computing system, the agent-specific costs are the computation workloads calculated for the respective agents, and the decision optimization and cost estimation system can assign the calculated computation workloads to the corresponding agents.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request to identify an optimal point in a continuous domain that maximizes a shared outcome function for a plurality of agents;
obtaining, for each of the plurality of agents, respective training data that comprises a respective utility score for each of a plurality of discrete points in the continuous domain;
training, for each of the plurality of agents and on the respective training data for the agents, a respective neural network that is configured to receive an input comprising a point in the continuous domain and to generate as output a predicted utility score for the agent at the point; and
identifying the optimal point by optimizing an approximation of the shared outcome function that is defined by, for any given point in the continuous domain, a combination of the predicted utility scores generated by the respective neural networks for each of the plurality of agents by processing an input comprising the given point.

2. The method of claim 1, wherein:
the shared outcome function includes a sum of predicted utility-value functions of the respective plurality of agents, each utility-value function being defined by, for any given point in the continuous domain, the predicted utility score generated by the respective neural network of the respective agent.

3. The method of claim 1, wherein identifying the optimal location includes:
locating one or more local maxima of the shared outcome function.

4. The method of claim 3, wherein locating the one or more local maxima of the shared outcome function includes:
selecting an initial point in the continuous domain; and
performing gradient ascent on the approximation of the shared outcome function to locate the local maxima of the shared outcome function.

5. The method of claim 3, wherein:
the one or more local maxima of the shared outcome function includes a plurality of local maxima; and
the method further includes:
identifying a global maximum from the plurality of local maxima; and
identifying a location of the global maximum as the optimal location.

6. The method of claim 1, further comprising:
calculating, using the respective neural networks for each of the agents, an agent-specific cost for each agent.

7. The method of claim 6, wherein calculating the agent-specific cost for the agent includes:
identifying, according to the sets of neural network parameters, an agent-specific reject location for the agent in the continuous domain that maximizes an agent-rejection outcome function with respect to locations in the continuous domain;
calculating a first sum of utility values of all other agents in the plurality of agents at the agent-specific rejection location;
calculating a second sum of utility values at the optimal location of all other agents in the plurality of agents; and
calculating the agent-specific cost for the agent according to the first sum of utility values and the second sum of utility values.

8. The method of claim 7, wherein the agent-rejection outcome function for the agent includes a sum of utility-value functions of all other agents in the plurality of agents, the utility-value function of an agent being defined by, for any given point in the continuous domain, the predicted utility score generated by the respective neural network of the agent.

9. The method of claim 8, wherein identifying the agent-specific rejection location for the agent includes:
locating one or more local maxima of the agent-rejection outcome function for the agent.

10. The method of claim 9, wherein locating the one or more local maxima of the agent-rejection outcome function includes:
calculating, according to the sets of neural network parameters, gradients of the agent-rejection outcome function; and
locating the local maxima of the agent-rejection outcome function using a gradient ascent algorithm.

11. The method of claim 1, wherein:
the discrete locations from the continuous domain include a plurality of randomly selected locations in the continuous domain.

12. The method of claim 1, wherein:
the continuous domain is a two-dimensional (2D) domain.

13. The method of claim 1, wherein:
the continuous domain is an N-dimensional domain with N≥3.

14. A system comprising one or more computers and one or more storage devices storing instructions that when executed by the one or more computers cause the one or more computers to perform:
receiving a request to identify an optimal point in a continuous domain that maximizes a shared outcome function for a plurality of agents;
obtaining, for each of the plurality of agents, respective training data that comprises a respective utility score for each of a plurality of discrete points in the continuous domain;
training, for each of the plurality of agents and on the respective training data for the agents, a respective neural network that is configured to receive an input comprising a point in the continuous domain and to generate as output a predicted utility score for the agent at the point; and
identifying the optimal point by optimizing an approximation of the shared outcome function that is defined by, for any given point in the continuous domain, a combination of the predicted utility scores generated by the respective neural networks for each of the plurality of agents by processing an input comprising the given point.

15. The system of claim 14, wherein:
the shared outcome function includes a sum of predicted utility-value functions of the respective plurality of agents, each utility-value function being defined by, for any given point in the continuous domain, the predicted utility score generated by the respective neural network of the respective agent.

16. The system of claim 14, wherein identifying the optimal location includes:
locating one or more local maxima of the shared outcome function.

17. The system of claim 16, wherein locating the one or more local maxima of the agent-rejection outcome function includes:
calculating, according to the sets of neural network parameters, gradients of the agent-rejection outcome function; and
locating the local maxima of the agent-rejection outcome function using a gradient ascent algorithm.

18. One or more computer storage media storing instructions that when executed by one or more computers cause the one or more computers to perform:
receiving a request to identify an optimal point in a continuous domain that maximizes a shared outcome function for a plurality of agents;
obtaining, for each of the plurality of agents, respective training data that comprises a respective utility score for each of a plurality of discrete points in the continuous domain;
training, for each of the plurality of agents and on the respective training data for the agents, a respective neural network that is configured to receive an input comprising a point in the continuous domain and to generate as output a predicted utility score for the agent at the point; and
identifying the optimal point by optimizing an approximation of the shared outcome function that is defined by, for any given point in the continuous domain, a combination of the predicted utility scores generated by the respective neural networks for each of the plurality of agents by processing an input comprising the given point.

19. The one or more computer storage media of claim 18, wherein:
the shared outcome function includes a sum of predicted utility-value functions of the respective plurality of agents, each utility-value function being defined by, for any given point in the continuous domain, the predicted utility score generated by the respective neural network of the respective agent.

20. The one or more computer storage media of claim 18, wherein identifying the optimal location includes:
locating one or more local maxima of the shared outcome function.
